(19) United States
(12) Patent Application Publication
(10) Pub. No.: US 2020/0132631 A1
(43) Pub. Date: Apr. 30, 2020

(54) RESONATOR SENSOR DEVICE

(71) Applicant: Samsung Electronics Co., Ltd., Suwon-si (KR)

(72) Inventors: Si-hoon LEE, Yongin-si (KR); Kwang-min PARK, Daejeon (KR); Min-chul LEE, Seongnam-si (KR); Jae-heung LIM, Suwon-si (KR)

(73) Assignee: Samsung Electronics Co., Ltd., Suwon-si (KR)

(21) Appl. No.: 16/505,874

(22) Filed: Jul. 9, 2019

(30) Foreign Application Priority Data
Oct. 29, 2018 (KR) 10-2018-0130235

(51) Int. Cl. G01N 29/02; G01N 29/036; G01N 29/32

(52) U.S. Cl. CPC G01N 29/022; G01N 2291/021; G01N 29/32; G01N 29/036

(57) ABSTRACT

A resonator sensor device includes a lower electrode located on a substrate, a piezoelectric layer located on the lower electrode, an upper electrode located on the piezoelectric layer, an upper passivation layer located on the upper electrode, the upper passivation layer including a hydrophobic material, and a gas sensing layer located on the upper passivation layer.

### CROSS-REFERENCE TO RELATED APPLICATION

This application claims the benefit of Korean Patent Application No. 10-2018-0130235, filed on Oct. 29, 2018, in the Korean Intellectual Property Office, the disclosure of which is incorporated herein in its entirety by reference.

### BACKGROUND

The inventive concepts relate to a resonator sensor device, and more particularly, to a resonator sensor device using a film bulk acoustic resonator (FBAR).

Resonator sensors using FBARs are advantageous for miniaturization and/or integration with mobile systems. A resonator sensor using an FBAR has a structure in which a lower electrode, a piezoelectric layer, and/or an upper electrode are stacked in order. The resonator sensor using the FBAR uses the principle that an acoustic wave is generated by a piezoelectric effect when electrical energy is applied to both electrodes and resonance occurs due to the acoustic wave.

### SUMMARY

The inventive concepts provide a sensor capable of providing increased stability of sensitivity and/or having improved durability.

Some example embodiments include a sensor system capable of detecting volatile organic compounds or gases.

According to some aspects of the inventive concepts, there is provided a resonator sensor device including: a lower electrode on a substrate; a piezoelectric layer on the lower electrode; an upper electrode on the piezoelectric layer; an upper passivation layer on the upper electrode, the upper passivation layer including a hydrophobic material; and a gas sensing layer on the upper passivation layer.

According to some aspects of the inventive concepts, there is provided a resonator sensor device including: a lower passivation layer on a substrate, the lower passivation layer including a hydrophobic material; a lower electrode on the lower passivation layer; a piezoelectric layer on the lower electrode; an upper electrode on the piezoelectric layer; an upper passivation layer on the upper electrode, the upper passivation layer including a hydrophobic material; and a gas sensing layer on the upper passivation layer.

According to some aspects of the inventive concepts, there is provided a resonator sensor device including: a lower electrode on a substrate; a piezoelectric layer on the lower electrode; an upper electrode on the piezoelectric layer; an upper passivation layer on the upper electrode, the upper passivation layer including a hydrophobic material; and a gas sensing layer on the upper passivation layer, wherein the upper passivation layer has a contact angle with water greater than 90 degrees.

### BRIEF DESCRIPTION OF THE DRAWINGS

Example embodiments of the inventive concept will be more clearly understood from the following detailed description taken in conjunction with the accompanying drawings in which:

FIG. 1 is a block diagram of a sensor system according to some example embodiments;

FIG. 2 is a block diagram of a sensor device according to some example embodiments;

FIG. 3 is a perspective view of a resonator sensor device according to some example embodiments;

FIG. 4 is a cross-sectional view of the resonator sensor device of FIG. 3;

FIG. 5 is a graph showing a change in the resonant frequency of the resonator sensor device of FIG. 3;

FIG. 6 is a cross-sectional view of a resonator sensor device according to some example embodiments;

FIG. 7 is a cross-sectional view of a resonator sensor device according to some example embodiments;

FIG. 8 is a cross-sectional view of a resonator sensor device according to some example embodiments; and

FIG. 9 is a graph showing frequency variations of resonator sensors according to some example embodiments.

### DETAILED DESCRIPTION OF THE EMBODIMENTS

Hereinafter, example embodiments of the inventive concepts will be described in detail with reference to the accompanying drawings.

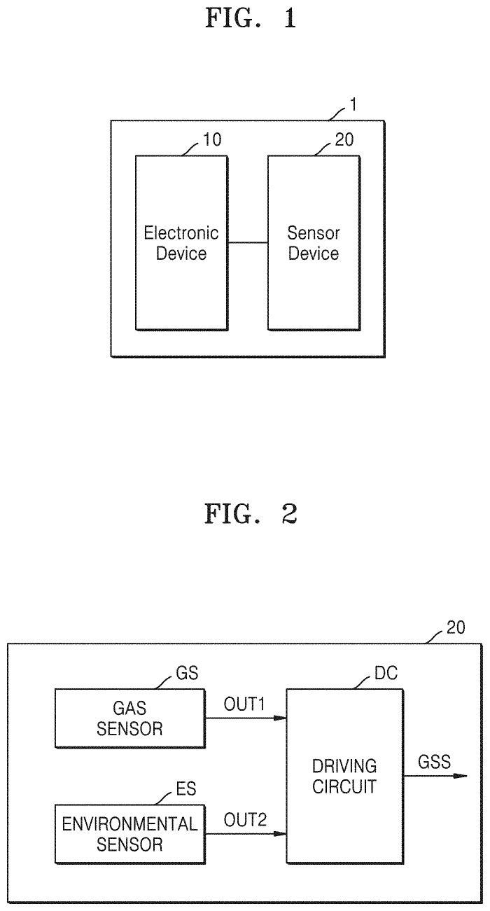

FIG. 1 is a block diagram of a sensor system 1 according to some example embodiments.

Referring to FIG. 1, the sensor system 1 may include an electronic device 10 and/or a sensor device 20. The electronic device 10 may be connected to the sensor device 20 via wire or wireless. The sensor system 1 may sense or measure odor, gas, and/or the like through the sensor device 20 and may be referred to as an “electronic nose system”.

The electronic device 10 may be a device including a function of sensing a change in odor due to a volatile organic compound and/or sensing a change in the content of a certain gas in the atmosphere. For example, the electronic device 10 may be at least one of a smartphone, a tablet personal computer (PC), a mobile phone, a videophone, an e-book reader, a desktop PC, a laptop PC, a netbook computer, a personal digital assistant (PDA), a portable multimedia player (PMP), an MP3 player, a mobile medical device, a camera, and/or a wearable device, and/or may be an electronic apparatus that may be connected to these various electronic apparatuses. Also, the electronic device 10 may be a smart home appliance including a function of sensing an odor change according to a temperature change. For example, the smart home appliance may include at least one of a television, a digital video disk (DVD) player, an audio player, a refrigerator, an air conditioner, a vacuum cleaner, an oven, a microwave oven, a washing machine, an air purifier, a set-top box, a TV box, a game console, an electronic dictionary, an electronic key, a camcorder, and/or an electronic frame.

The sensor device 20 may be a device that performs a function of sensing a change in odor due to a volatile organic compound and/or sensing a change in the content of a certain gas in the atmosphere. For example, the sensor device 20 may include a resonator sensor of a film bulk acoustic resonator (FBAR) type. The sensor device 20 may further include an appropriate interface for performing mutual communication with the electronic device 10. For example, the connection between the sensor device 20 and the electronic device 10 may be connected through any one of I²C, serial peripheral interface (SPI), universal serial bus (USB), high-definition multimedia interface (HDMI), and/or mobile industry processor Interface (MIPI), and/or may be connected through a wired or wireless communication protocol.

FIG. 2 is a block diagram of a sensor device 20 according to some example embodiments.

Referring to FIG. 2, the sensor device 20 may include a gas sensor GS, an environmental sensor ES, and/or a driving circuit DC. The sensor device 20 may sense and/or measure odor, gas, and/or the like and thus may be referred to as an “electronic nose system”.

The gas sensor GS may output a first sensing result OUT1 by sensing gas in the air. The environmental sensor ES may output a second sensing result OUT2 by sensing environmental factors such as temperature, humidity, atmospheric pressure, light, and/or the like. The driving circuit DC may generate a gas sensing signal GSS by receiving the first and second sensing results OUT1 and OUT2 and correcting the first sensing result OUT1 based on the second sensing result OUT2.

In some example embodiments, the gas sensor GS and/or the environmental sensor ES may each be implemented with a resonance type device including a resonator. For example, the gas sensor GS and/or the environmental sensor ES may each include an FBAR. Accordingly, the gas sensor GS and/or the environmental sensor ES may be referred to as FBAR sensors. The sensor device 20 (and/or sensor system) including such an FBAR sensor may be used as an electronic nose system to sense various kinds of gases harmful to the human body, for example, to sense a change in odor due to a volatile organic compound and/or a change in the content of a certain gas in the atmosphere. According to some example embodiments, the sensor device 20 may be implemented using a plurality of FBARs coated with polymers responsive to a certain gas, and/or may be efficiently mounted on a small-sized mobile product.

The driving circuit DC may include an oscillator (not shown), which may output an oscillation signal operating at a frequency corresponding to the resonant frequency of a resonator in each of the gas sensor GS and/or the environmental sensor ES. For example, a first oscillator (not shown) may output an oscillation signal (e.g., a first sensing result OUT1) having a frequency corresponding to the resonant frequency of the gas sensor GS, and/or a second oscillator (not shown) may output an oscillation signal (e.g., a second sensing result OUT2) having a frequency corresponding to the resonant frequency of the environmental sensor GS.

The driving circuit DC may include processing circuitry including, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. In some example embodiments, the driving circuit DC may be at least one of an application-specific integrated circuit (ASIC) and/or an ASIC chip.

The driving circuit DC may be configured as a special purpose machine by executing computer-readable program code stored on a storage device. The program code may include program or computer-readable instructions, software elements, software modules, data files, data structures, and/or the like, capable of being implemented by one or more hardware devices, such as one or more instances of the driving circuit DC mentioned above. Examples of program code include both machine code produced by a compiler and higher level program code that is executed using an interpreter.

In some example embodiments, the gas sensor GS may include an FBAR and/or a polymer, and when gas is adsorbed onto the polymer, the resonant frequency of the FBAR may be changed. However, the resonant frequency of the FBAR included in the gas sensor GS may be changed by other environmental factors other than the adsorption of the gas, for example, such as temperature, humidity, particles, atmospheric pressure, light, and/or flow of gas. In other words, the first sensing result OUT1 of the gas sensor GS may include an effect caused by other environmental factors, in addition to a gas sensing result. Thus, a correction circuit (not shown) included in the driving circuit DC may subtract the second sensing result OUT2 obtained from the environmental sensor ES from the first sensing result OUT1 obtained from the gas sensor GS and generate a gas sensing signal GSS according to the gas sensing result.

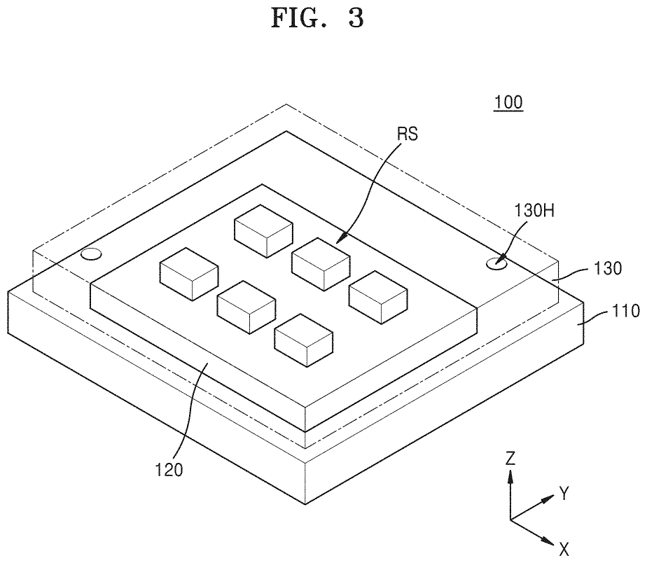

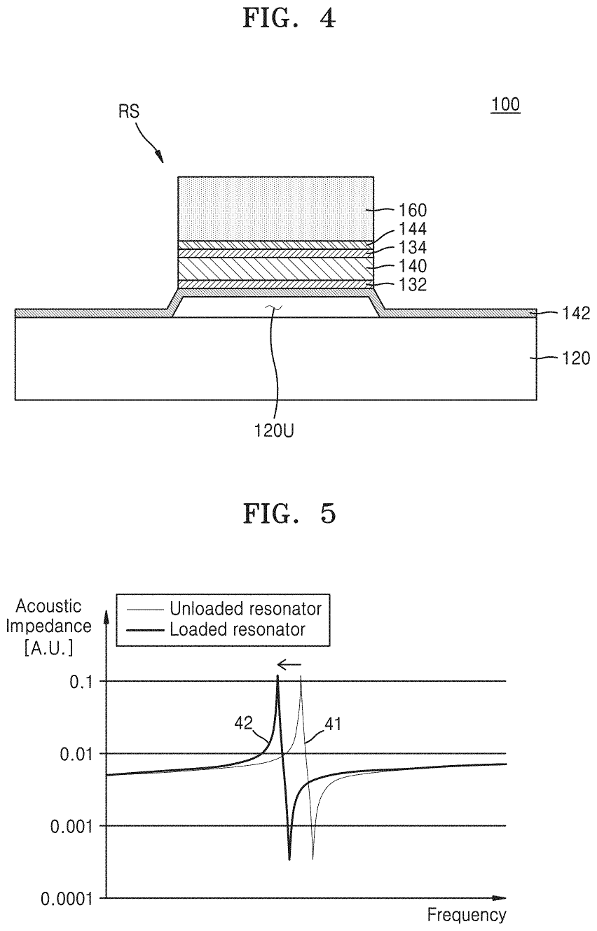

FIG. 3 is a perspective view of a resonator sensor device 100 according to some example embodiments. FIG. 4 is a cross-sectional view of the resonator sensor device 100. In FIG. 4, some components such as a package substrate 110 and/or a cover member 130 are omitted for convenience of illustration.

Referring to FIGS. 3 and 4, the resonator sensor device 100 may include the package substrate 110, a substrate 120, at least one resonator sensor RS, and/or the cover member 130.

The package substrate 110 may include at least one of a printed circuit board (PCB), an interposer, a silicon substrate, a glass substrate, and/or a ceramic substrate. The package substrate 110 may further include a wiring line (not shown) and/or a via structure (not shown) for electrical connection with the substrate 120 and/or the at least one resonator sensor RS.

In some example embodiments, a driving semiconductor chip (not shown) may be further located on the package substrate 110, and the driving semiconductor chip may include an application processor for driving the at least one resonator sensor RS. In some example embodiments, a driving circuit unit (not shown) may be further formed inside the package substrate 110, and the driving circuit unit may include an application processor for driving the at least one resonator sensor RS.

The substrate 120 may be located on the package substrate 110. The substrate 120 may include a semiconductor substrate including a material such as silicon, germanium, silicon germanium, gallium arsenide, and/or indium phosphide.

The at least one resonator sensor RS may be located on the substrate 120. The at least one resonator sensor RS may sense a particular type of volatile organic compound and/or gas. In FIG. 3, six resonator sensors RS are illustrated by way of example, and the six resonator sensors RS may sense six types of volatile organic compounds and/or gases. However, the number of resonator sensors RS is not limited to that shown in the drawings. The at least one resonator sensor RS may include a resonator sensor of the FBAR type.

Alternatively, at least one environmental sensor (not shown) may be further located on the substrate 120. For example, the at least one environmental sensor may include a humidity sensor and/or a temperature sensor. The at least one environmental sensor may be implemented as a CMOS circuit formed on the substrate 120. However, the inventive concepts are not limited thereto.

The cover member 130 may be located on the package substrate 110. The cover member 130 may cover both the at least one resonator sensor RS and the substrate 120. A portion of the cover member 130 may be spaced apart from the at least one resonator sensor RS and/or the substrate 120 so that an air space (not shown) is located on the at least one resonator sensor RS and/or the substrate 120.

A plurality of openings 130H may be formed on the upper surface of the cover member 130, and/or the at least one resonator sensor RS may be exposed to the atmosphere outside the resonator sensor device 100 through the plurality of openings 130H. For example, a volatile organic compound and/or gas present in the atmosphere may be diffused into the air space through the plurality of openings 130H, and the at least one resonator sensor RS may sense the volatile organic compound and/or gas.

The at least one resonator sensor RS may be located on the substrate 120. The at least one resonator sensor RS may include a lower electrode 132, an upper electrode 134, a piezoelectric layer 140, a lower passivation layer 142, an upper passivation layer 144, and/or a gas sensing layer 160.

The lower passivation layer 142 may be located on the substrate 120. The lower passivation layer 142 may include a hydrophobic material and may act as a protective film for reducing or preventing the performance of the at least one resonator sensor RS from varying due to a change in the surrounding environment, for example, due to moisture in the atmosphere. The lower passivation layer 142 may also function as a stress release layer to mitigate stress that may be caused by a difference between the material of the substrate 120 and/or the material of the at least one resonator sensor RS. In some example embodiments, the hydrophobic material may include a hydrophobic inorganic material. The lower passivation layer 142 may include, for example, silicon nitride (SiN), aluminum nitride (AlN), silicon carbide (SiC), and/or silicon oxycarbide (SiOC).

A cavity 120U may be located between a portion of the substrate 120 and the lower passivation layer 142. For example, the substrate 120 may not contact the lower passivation layer 142 in an area vertically overlapping the cavity 120U and/or may contact the lower passivation layer 142 in an area not vertically overlapping the cavity 120U. A gas sensing area (not shown) of the at least one resonator sensor RS may be located above the cavity 120U. Although not shown in the drawings, the cavity 120U may have various shapes such as a circle, a rectangle, a triangle, and/or a polygon in a plan view. In a manufacturing process, after a sacrificial layer (not shown) is formed on the substrate 120 and/or the lower passivation layer 142 covering the sacrificial layer is formed, the cavity 120U may be formed between the substrate 120 and the lower passivation layer 142 by selectively removing the sacrificial layer by using an etching process or the like.

A stacked structure in which the lower electrode 132, the piezoelectric layer 140, the upper electrode 134, and/or the upper passivation layer 144 are sequentially stacked may be located on the lower passivation layer 142. The gas sensing layer 160 may be located on the upper passivation layer 144. The stacked structure may vertically overlap the cavity 120U.

The resonant frequency of the at least one resonator sensor RS may be determined by the thickness of the piezoelectric layer 140. When a radio frequency (RF) voltage corresponding to the resonant frequency is applied through the lower electrode 132 and/or the upper electrode 134, the at least one resonator sensor RS may resonate along a direction in which the lower electrode 132, the piezoelectric layer 140, and/or the upper electrode 134 are stacked (for example, along a direction perpendicular to the upper surface of the substrate 120).

In some example embodiments, the lower electrode 132 and/or the upper electrode 134 may each include a metal such as molybdenum (Mo), ruthenium (Ru), gold (Au), aluminum (Al), platinum (Pt), titanium (Ti), tungsten (W), palladium (Pd), chromium (Cr), and/or nickel (Ni). A portion of the lower electrode 132 and/or a portion of the upper electrode 134 may vertically overlap the cavity 120U.

The piezoelectric layer 140 may be located between the lower electrode 132 and the upper electrode 134 and/or may include aluminum nitride (AlN), zinc oxide (ZnO), lead zirconium titanium oxide (PbZrTiOₓ, PZT) and/or any one of various types of piezoelectric materials.

The upper passivation layer 144 may include a hydrophobic material and/or may act as a protective film for reducing or preventing the performance of the at least one resonator sensor RS from varying due to a change in the surrounding environment, for example, due to moisture in the atmosphere. For example, the lower passivation layer 142 and/or the upper passivation layer 144 may effectively reduce or prevent a drift phenomenon that an output frequency of the at least one resonator sensor RS varies depending on an operating environment of the at least one resonance sensor RS. In some example embodiments, the upper passivation layer 144 may include a hydrophobic inorganic material. For example, the hydrophobic inorganic material may include at least one of SiN, AlN, SiC, and/or SiOC.

In some example embodiments, the lower passivation layer 142 and/or the upper passivation layer 144 may be formed on the lower electrode 132 and/or the upper electrode 134, respectively, by using a chemical vapor deposition (CVD) process, an atomic layer deposition (ALD) process, a spin coating process, and/or the like. The lower passivation layer 142 may include the same material as the upper passivation layer 144, but is not limited thereto. The lower passivation layer 142 may be formed in the same process as the upper passivation layer 144. Alternatively, the upper passivation layer 144 may be formed after the lower passivation layer 142 is formed. Although the lower passivation layer 142 and the upper passivation layer 144 are shown as single material layers, each of the lower passivation layer 142 and/or the upper passivation layer 144 may be formed as a stacked structure including a plurality of material layers.

The upper passivation layer 144 may have a first thickness in a first direction perpendicular to the upper surface of the substrate 120, and/or the first thickness may be about 10 nm to about 300 nm. The lower passivation layer 142 may have a second thickness in the first direction, and/or the second thickness may be about 10 nm to about 300 nm. The first thickness may be equal to the second thickness, but is not limited thereto.

The lower passivation layer 142 and/or the upper passivation layer 144 may have a contact angle to water greater than about 90 degrees. The contact angle to water refers to the angle between a droplet and a solid surface when the droplet is placed on the solid surface. The lower passivation layer 142 and/or the upper passivation layer 144 may include a hydrophobic material, and thus, the contact angle to water may be greater than about 90 degrees and less than about 180 degrees.

The upper passivation layer 144 may cover substantially the entire area of the upper surface of the upper electrode 134. The lower passivation layer 142 may cover the entire bottom surface of the lower electrode 132 facing the cavity 120U, and thus, the bottom surface of the lower electrode 132 may not be exposed to the inner wall of the cavity 120U. The upper electrode 134 and/or the lower electrode 132 may not be directly exposed to an air space (and/or ambient atmosphere) due to the upper passivation layer 144 and/or the lower passivation layer 142.

Although not shown in the drawings, bonding pads (not shown) may be further formed to be connected to the lower electrode 132 and/or the upper electrode 134, respectively. Bonding wires (not shown) may be further located on the bonding pads to electrically connect an external device to the resonator sensor RS.

The gas sensing layer 160 may be located on the upper passivation layer 144, and/or the upper passivation layer 144 may be interposed between the upper electrode 134 and the gas sensing layer 160. The gas sensing layer 160 may include a gas adsorbing layer capable of adsorbing a certain type of volatile organic compound and/or gas. For example, the gas sensing layer 160 may include a reactive material capable of selectively adsorbing at least one target material selected from a volatile organic compound, such as methanol, ethanol, n-propanol, i-propanol, acetone, toluene, formaldehyde, acetaldehyde, and/or benzene, and/or a gas, such as ammonia, carbon dioxide, nitrogen monoxide, and/or hydrogen sulfide. For example, when six resonator sensors RS are formed as shown in FIG. 3, each of the gas sensing layers 160 in the six resonator sensors RS may selectively adsorb six different target materials among methanol, ethanol, n-propanol, i-propanol, acetone, toluene, formaldehyde, acetaldehyde, benzene, ammonia, carbon dioxide, nitrogen monoxide, and/or hydrogen sulfide.

In some example embodiments, the reactive material of the gas sensing layer 160 may include, but is not limited to, polymers, porous metal oxide particles, metal oxide nanotubes, carbon nanotubes, and/or the like.

Hereinafter, the driving principle of the resonator sensor device 100 is briefly described with reference to FIG. 5.

FIG. 5 is a graph showing a change in the resonant frequency of the resonator sensor device 100.

Referring to FIG. 5, a first graph 41 represents the resonant frequency of the resonator sensor RS when no target material is adsorbed onto the gas sensing layer 160 and a second graph 42 represents the resonant frequency of the resonator sensor RS when a target material is adsorbed onto the gas sensing layer 160.

In a bulk acoustic wave resonator model, a resonant frequency change may be obtained according to a mass change induced in the resonator sensor RS, as expressed by Equation (1).

$$Δ f = - \frac{2 {f}_{0}^{2}}{A \sqrt{{ρ}_{q} {μ}_{q}}} Δ m \qquad ( 1 )$$

Here, Δf and f₀ denote a frequency variation and a resonant frequency of the resonator sensor RS, respectively. μ_{q} and ρ_{q} denote a shear modulus of the material of the piezoelectric layer 140 and density of the material of the piezoelectric layer 140, respectively. A denotes the area of a gas sensing area, and Δm denotes a changed mass. That is, according to Equation (1), a frequency variation of the resonator sensor RS may occur depending on a change in the mass of the resonator sensor RS, for example, a change in the mass of a target material adsorbed onto the gas sensing layer 160.

As shown in FIG. 5, when a target material is adsorbed onto the gas sensing layer 160, the resonant frequency of the resonator sensor RS may be changed, and accordingly, the frequency of an oscillation signal (e.g., a sensing signal) output from an oscillator may be changed. Thus, by detecting the frequency of the output signal and/or the sensing signal from the oscillator, it is possible to sense whether or not the target material is adsorbed, and an adsorption amount of the target material may be calculated.

Referring back to FIG. 3, in the resonator sensor device 100 according to some example embodiments, as the lower passivation layer 142 and/or the upper passivation layer 144 include a hydrophobic material and/or cover the entire bottom surfaces and/or entire upper surfaces of the lower electrode 132 and/or the upper electrode 134, the sensing accuracy of the resonator sensor device 100 may be improved.

A resonator sensor device needs to have precise sensitivity to a certain target material even under various circumstances. For example, even if the temperature and/or humidity around the resonator sensor device changes, the frequency of the output signal of the resonator sensor device has to be unchanged. However, in a general resonator sensor device, when moisture penetrates into a passivation layer, a drift phenomenon, in which the output frequency of the general resonator sensor device varies due to a change in the mass of moisture adsorbed into the passivation layer, may occur. A resonator sensor with a drift characteristic may exhibit unstable sensitivity according to a change in the surrounding environment. Thus, as the period of use of the resonator sensor increases, the sensitivity of the resonator sensor may decrease and/or life of usage (and/or durability) of the resonator sensor may be shortened.

On the other hand, according to the resonator sensor device 100 according to some example embodiments, the lower passivation layer 142 and/or the upper passivation layer 144 may include a hydrophobic material, and/or the amount of moisture adsorbed into the lower passivation layer 142 and/or the upper passivation layer 144 may be significantly reduced. Thus, the drift phenomenon may be reduced or prevented and/or the resonator sensor device 100 may have stable sensitivity even if the ambient temperature and/or humidity of the resonator sensor device 100 changes. Also, deterioration in sensitivity due to the passage of the usage period may be reduced or prevented, and thus, the resonator sensor device 100 may have improved durability.

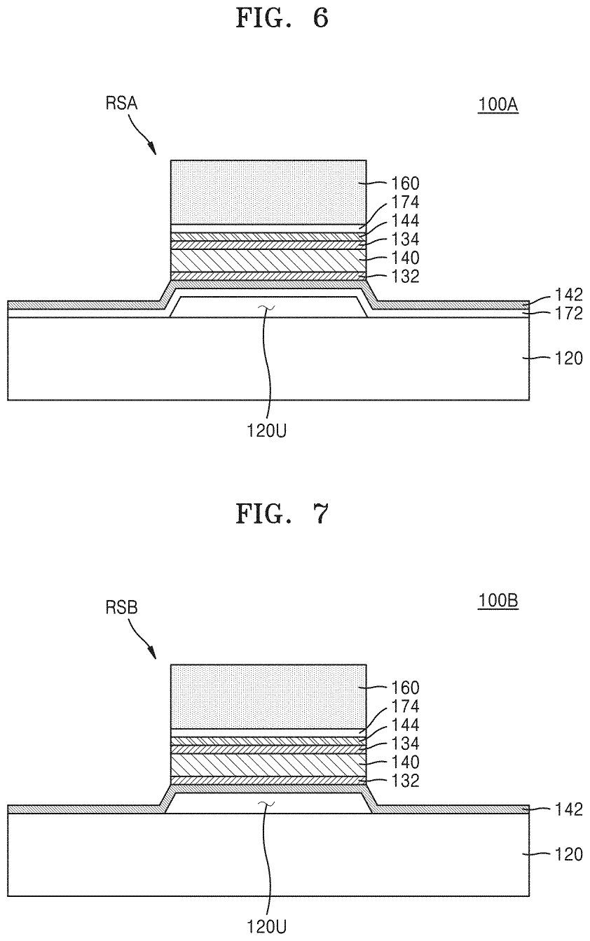

FIG. 6 is a cross-sectional view of a resonator sensor device 100A according to some example embodiments. In FIG. 6, reference numerals that are the same as those in FIGS. 1 to 5 denote components that are the same as those in FIGS. 1 to 5.

Referring to FIG. 6, a resonator sensor RSA may include a lower moisture-proof capping layer 172 and/or an upper moisture-proof capping layer 174. The lower moisture-proof capping layer 172 may be located between a substrate 120 and a lower passivation layer 142 and/or the surface of the lower moisture-proof capping layer 172 may be exposed by a cavity 120U. The upper moisture-proof capping layer 174 may be located between an upper passivation layer 144 and a gas sensing layer 160.

As shown in FIG. 6, the lower moisture-proof capping layer 172, the lower passivation layer 142, a lower electrode 132, a piezoelectric layer 140, an upper electrode 134, the upper passivation layer 144, the upper moisture-proof capping layer 174, and/or the gas sensing layer 160 may be sequentially located on the substrate 120.

In some example embodiments, the lower passivation layer 142 and/or the upper passivation layer 144 may include at least one of aluminum oxide, silicon nitride, aluminum nitride, silicon carbide, and/or silicon oxycarbide.

In some example embodiments, the lower moisture-proof capping layer 172 and/or the upper moisture-proof capping layer 174 may include a hydrophobic polymer such as a fluorine-based polymer, a polymer including a methyl group, an aliphatic polymer, and/or an aromatic polymer. The hydrophobic polymer may include at least one of a fluorine-based polymer, a polymer including a methyl group, an aliphatic polymer, and/or an aromatic polymer.

For example, a fluorine-based polymer having hydrophobicity may include at least one of polytetrafluoroethylene (PTFE), polyvinylidene fluoride (PVDF), perfluoroalkoxy alkane (PFA), fluorinated ethylene propylene (FEP), ethylene tetrafluoroethylene (ETFE), and/or polychlorotrifluoroethylene (PCTFE), but is not limited thereto. A polymer including a methyl group, which has hydrophobicity, may include any one selected from polyacrylate including polymethyl methacrylate (PMMA), polyisoprene, polypropylene, and/or polystyrene, but is not limited thereto. For example, an aliphatic polymer having hydrophobicity may include any one selected from oleic acid, stearic acid, 1-decanethiol, 1-undecanethiol, 1-dodecanethiol, 1-tetradecanethiol, 1-pentadecanethiol, 1-hexadecanethiol, 1-octadecanethiol, hexadecyltrichlorosilane, n-octadecyltriethoxysilane, n-octadecyldimethylchlorosilane, n-octadecylmethoxydichlorosilane, hexadecyltrimethoxysilane, triacontyldimethylchlorosilane, and/or triacontyltrichlorosilane, but is not limited thereto. For example, an aromatic polymer having hydrophobicity may be an aromatic polymer including aromatic hydrocarbon such as phenol, benzene, ethylbenzene, chlorobenzene, toluene, and/or xylene, but is not limited thereto.

According to the resonator sensor device 100A according to some example embodiments, the upper passivation layer 144 and/or the upper moisture-proof capping layer 174 may be sequentially located between the upper electrode 134 and the gas sensing layer 160, and/or the lower passivation layer 142 and/or the lower moisture-proof capping layer 172 may be sequentially located between the lower electrode 132 and the cavity 120U. Accordingly, the amount of moisture adsorbed into the upper passivation layer 144 and/or the upper moisture-proof capping layer 174, and/or in the lower passivation layer 142 and/or the lower moisture-proof capping layer 172 may be significantly reduced.

Thus, a drift phenomenon of the resonator sensor device 100A may be reduced or prevented, and/or the resonator sensor device 100A may have stable sensitivity even if the ambient temperature and/or humidity of the resonator sensor device 100A changes. Also, deterioration in sensitivity due to the passage of the usage period may be reduced or prevented, and thus, the resonator sensor device 100A may have excellent durability.

FIG. 7 is a cross-sectional view of a resonator sensor device 100B according to some example embodiments. In FIG. 7, reference numerals that are the same as those in FIGS. 1 to 6 denote components that are the same as those in FIGS. 1 to 6.

Referring to FIG. 7, a resonator sensor RSB may further include an upper moisture-proof capping layer 174, and the upper moisture-proof capping layer 174 may be located between an upper passivation layer 144 and a gas sensing layer 160.

In a manufacturing process, a sacrificial layer (not shown) may be formed on a substrate 120 by using polysilicon and then a lower passivation layer 142, a lower electrode 132, a piezoelectric layer 140, an upper electrode 134, an upper moisture-proof capping layer 174, and/or an upper passivation layer 144 may be sequentially formed. Thereafter, the sacrificial layer may be removed to thereby form a cavity 120U in a space from which the sacrificial layer is removed. A process of removing the sacrificial layer may be a wet etching process using an etchant solution and/or a dry etching process using an etching gas including fluorine. For example, the lower passivation layer 142 may include a material having etch selectivity with respect to the material of the sacrificial layer and may not be, for example, removed and/or damaged in the process of removing the sacrificial layer.

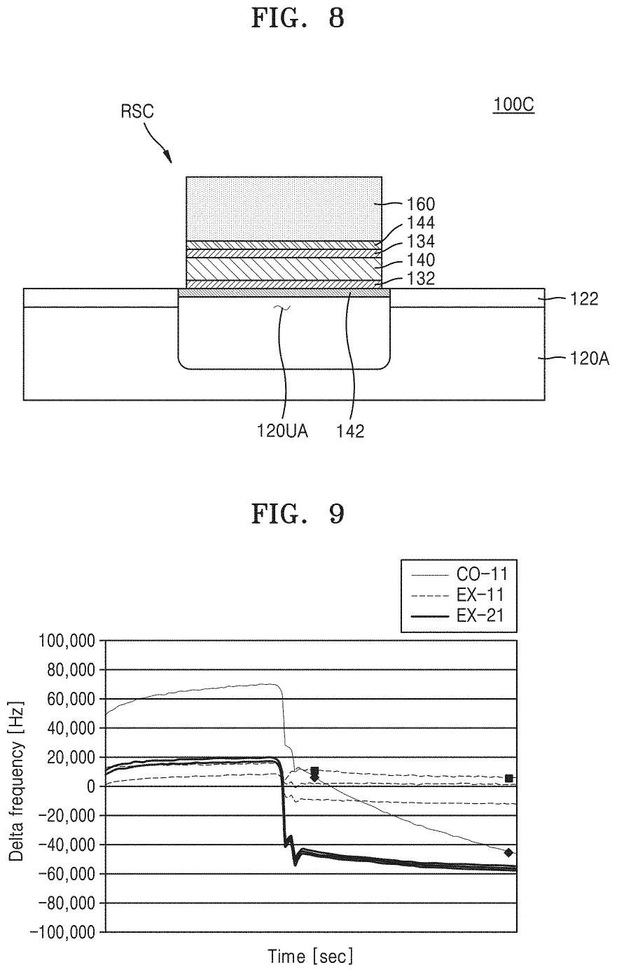

FIG. 8 is a cross-sectional view of a resonator sensor device 100C according to some example embodiments. In FIG. 8, reference numerals that are the same as those in FIGS. 1 to 7 denote components that are the same as those in FIGS. 1 to 7.

Referring to FIG. 8, a resonator sensor RSC may be located on a substrate 120A including a cavity 120UA. The substrate 120A may include the cavity 120UA and an upper portion of the cavity 120UA may be surrounded by a lower insulating layer 122. The lower insulating layer 122 may include an insulating material such as silicon oxide, silicon nitride, silicon oxynitride, and/or aluminum oxide.

In some example embodiments, the cavity 120UA may be formed by removing a portion of the substrate 120A by an anisotropic etching process, a laser drilling process, and/or the like. In other example embodiments, the cavity 120UA may be formed by a backside etching process for the substrate 120A. Unlike the case shown in FIG. 8, the cavity 120UA may extend to the bottom surface of the substrate 120A and thus the cavity 120UA may penetrate the substrate 120A.

A lower passivation layer 142 may be located on the entire area of the bottom surface of a lower electrode 132 facing the cavity 120UA and may not be located between the lower electrode 132 and the lower insulating layer 122.

FIG. 9 is a graph showing frequency variations of resonator sensors EX-11 and EX21 according to some example embodiments. For comparison, a frequency variation of a resonator sensor CO-11 according to a comparative example is also shown in FIG. 9.

Referring to FIG. 9, the resonator sensor CO-11 according to the comparative example is manufactured to include a general passivation layer (for example, a passivation layer including silicon oxide). The resonator sensor EX-11 according to a first example embodiment has the same structure as the resonator sensor RS described with reference to FIGS. 3 and 4 and is manufactured to include aluminum nitride as the lower and/or upper passivation layers 142 and/or 144. The resonator sensor EX-21 according to a second example embodiment has the same structure as the resonator sensor RSA described with reference to FIG. 6 and is manufactured to include aluminum oxide as the lower and/or upper passivation layers 142 and/or 144 and include a fluorine-based polymer as the lower and/or upper moisture-proof capping layers 172 and/or 174. The resonator sensors EX-11 and EX-21 according to the first and second example embodiments and the resonator sensor CO-11 according to the comparative example are placed in an airtight environment without supply of gas or volatile organic compound from the outside, and changes in the resonant frequencies of the resonator sensors EX-11, EX-21, and CO-11 over time are measured at the same temperature and humidity (for example, a temperature of 20° C. and 80% relative humidity).

As shown in FIG. 9, the resonator sensor CO-11 according to the comparative example exhibits a frequency variation value that changes with time. That is, the resonator sensor CO-11 according to the comparative example exhibits a considerable drift characteristic. For example, the resonator sensor CO-11 according to the comparative example exhibits a frequency variation value of about 338 kHz. The drift characteristic indicates a phenomenon in which a sensor output varies with time under a certain environment. A resonator sensor with the drift characteristic may exhibit unstable sensitivity according to a change in the surrounding environment, and thus, as the period of use of the resonator sensor increases, the sensitivity of the resonator sensor may decrease and/or the durability of the resonator sensor may be deteriorated.

On the other hand, in the resonator sensors EX-11 and/or EX-21 according to the first and/or second example embodiments, a frequency variation value is insignificant even after a lapse of time and a drift phenomenon is remarkably reduced or prevented. For example, the resonator sensors EX-11 and/or EX-21 according to the first and/or second example embodiments, respectively, exhibit remarkably low frequency variation values of 10 kHz and 5 kHz, respectively.

This is because the variation of the output frequency of the resonator sensor CO-11 according to the comparative example increases as moisture penetrates and/or is adsorbed into a passivation layer in the resonator sensor CO-11, while the resonator sensors EX-11 and/or EX-21 according to the first and/or second example embodiments may effectively reduce or prevent moisture penetration and/or adsorption into lower and/or upper passivation layers including a hydrophobic material. Thus, the output frequencies of the resonator sensors EX-11 and/or EX-21 hardly vary.

While the inventive concepts have been particularly shown and described with reference to example embodiments thereof, it will be understood that various changes in form and/or details may be made therein without departing from the spirit and/or scope of the following claims.

What is claimed is:

1. A resonator sensor device comprising:
a lower electrode on a substrate;
a piezoelectric layer on the lower electrode;
an upper electrode on the piezoelectric layer;
an upper passivation layer on the upper electrode, the upper passivation layer including a first hydrophobic material; and
a gas sensing layer on the upper passivation layer.

2. The resonator sensor device of claim 1, further comprising
a lower passivation layer between the substrate and the lower electrode, the lower passivation layer including a second hydrophobic material.

3. The resonator sensor device of claim 2, wherein
the substrate and the lower passivation layer are partially separated by a cavity, the cavity vertically overlapping the lower electrode, the piezoelectric layer, and the upper electrode.

4. The resonator sensor device of claim 1, wherein the upper passivation layer has a first thickness of about 10 nm to about 300 nm in a first direction perpendicular to an upper surface of the substrate.

5. The resonator sensor device of claim 1, wherein
the upper passivation layer comprises a hydrophobic inorganic material, the hydrophobic inorganic material comprises at least one of silicon nitride, aluminum nitride, silicon carbide, and silicon oxycarbide.

6. The resonator sensor device of claim 1, further comprising
an upper moisture-proof capping layer between the upper passivation layer and the gas sensing layer.

7. The resonator sensor device of claim 6, wherein
the upper moisture-proof capping layer comprises a hydrophobic polymer, and
the hydrophobic polymer comprises at least one of a fluorine-based polymer, a polymer including a methyl group, an aliphatic polymer, and an aromatic polymer.

8. The resonator sensor device of claim 6, further comprising
a lower passivation layer on a bottom surface of the lower electrode, the lower passivation layer including a second hydrophobic material, and
a lower moisture-proof capping layer on a bottom surface of the lower passivation layer.

9. The resonator sensor device of claim 1, wherein the upper passivation layer covers an entire upper surface of the upper electrode.

10. The resonator sensor device of claim 1, wherein the upper passivation layer has a contact angle with water greater than 90 degrees.

11. The resonator sensor device of claim 1, wherein the substrate comprises a cavity, and the resonator sensor device further comprises
a lower passivation layer including a second hydrophobic material, the lower passivation layer on a bottom surface of the lower electrode facing the cavity.

12. A resonator sensor device comprising:
a lower passivation layer on a substrate, the lower passivation layer including a first hydrophobic material;
a lower electrode on the lower passivation layer;
a piezoelectric layer on the lower electrode;
an upper electrode on the piezoelectric layer;
an upper passivation layer on the upper electrode, the upper passivation layer including a second hydrophobic material; and
a gas sensing layer on the upper passivation layer.

13. The resonator sensor device of claim 12, wherein the upper passivation layer covers an entire upper surface of the upper electrode, and the lower passivation layer covers an entire bottom surface of the lower electrode.

14. The resonator sensor device of claim 12, wherein the upper passivation layer and the lower passivation layer each have a contact angle with water greater than 90 degrees.

15. The resonator sensor device of claim 12, further comprising
a lower moisture-proof capping layer between the lower passivation layer and the substrate, and
an upper moisture-proof capping layer between the upper passivation layer and the gas sensing layer,
wherein each of the lower moisture-proof capping layer and the upper moisture-proof capping layer comprises a hydrophobic polymer.

16. The resonator sensor device of claim 12, wherein
the lower passivation layer and the substrate are partially separated by a cavity, and
the lower electrode is not exposed to an inner wall of the cavity.

17. A resonator sensor device comprising:
a lower electrode on a substrate;
a piezoelectric layer on the lower electrode;
an upper electrode on the piezoelectric layer;
an upper passivation layer on the upper electrode, the upper passivation layer including a first hydrophobic material; and
a gas sensing layer on the upper passivation layer,
wherein the upper passivation layer has a contact angle with water greater than 90 degrees.

18. The resonator sensor device of claim 17, further comprising
a lower passivation layer between the substrate and the lower electrode, the lower passivation layer including a second hydrophobic material, the lower passivation layer and the substrate partially separated by a cavity at a position vertically overlapping the lower electrode.

19. The resonator sensor device of claim 18, wherein the upper passivation layer covers an entire upper surface of the upper electrode, and the lower passivation layer covers an entire bottom surface of the lower electrode facing the cavity.

20. The resonator sensor device of claim 17, wherein the substrate comprises a cavity, and the resonator sensor device further comprises a lower passivation layer including a second hydrophobic material and being located on a bottom surface of the lower electrode facing the cavity.
